(19) United States
(12) Patent Application Publication
(10) Pub. No.: US 2016/0037137 A1
(43) Pub. Date: Feb. 4, 2016

(54) SENSORY PERCEPTION ENHANCEMENT DEVICE

(71) Applicant: Philip Seiflein, Ojai, CA (US)

(72) Inventor: Philip Seiflein, Ojai, CA (US)

(21) Appl. No.: 14/798,247

(22) Filed: Jul. 13, 2015

Related U.S. Application Data
(60) Provisional application No. 61/999,562, filed on Jul. 31, 2014.

(51) Int. Cl. H04N 7/18; H04N 5/44; G02B 27/01; G06T 11/60; H04N 5/232; G06F 3/01

(52) U.S. Cl. CPC H04N 7/185; H04N 5/23293; G06F 3/013; G06F 3/016; G02B 27/017; G06T 11/60; H04N 5/44; G02B 2027/0178

(57) ABSTRACT

The system includes a head mounted, wearable device with at least one sensory output device for conveying information about the surrounding environment to a user and at least one enhancement device coupled to the wearable device. The enhancement device includes at least one imaging device configured to receive real-time images, and a feedback system configured to process the real-time images to obtain the information about the surrounding environment and to transmit the information to the sensory output device.

### CROSS REFERENCE TO RELATED APPLICATION

This application claims the benefit of U.S. Provisional Application No. 61/999,562, which was filed on Jul. 31, 2014, and is incorporated herein by reference in its entirety.

### FIELD

The present disclosure is directed to sensory perception enhancement devices.

### BACKGROUND

People rely on sight, sound, touch and, other perceptive resources to provide information about the world. When these senses fail or do not function normally, a person's ability to engage with the world can be negatively impacted. For example, persons with failing vision may experience gaps of darkness in their eyesight and these perception gaps cause a lessened image to appear in the brain. As a result of this deterioration in eyesight perception, other perception and related issues can arise, such as, for example, disorientation, loss of balance, acute-emotional neurosis, stress, depression, and/or other types of loss can occur as a result of the loss of visual perception.

Because of the important safety, health, and quality of life issues associated with the ability to perceive information about one's surrounding environment, improvements in the manner in which information from deficient, aberrant, or absent perceptions can be conveyed to a person are desirable.

### SUMMARY

The present disclosure relates to using devices and methods to enhance deficient, aberrant, or absent perceptions and provide a modality that can present information about the surrounding environment to a user in a useful manner.

In some embodiments, the systems and methods can provide a host unit and attachments that can replace or supplement one or more missing perceptions through a combination of software and hardware. In some embodiments, artificial intelligence enhancement induced agent protocols can correct or improve a particular perception perception through custom algorithms made to address the user's specific lacking or abnormal perception.

In one embodiment, a sensory enhancement system is provided. The system includes a head mounted, wearable device with at least one sensory output device for conveying information about the surrounding environment to a user and at least one enhancement device coupled to the wearable device. The enhancement device includes at least one imaging device configured to receive real-time images, and a feedback system configured to process the real-time images to obtain the information about the surrounding environment and to transmit the information to the sensory output device.

In some embodiments, the imaging device comprises at least one video camera and the at least one sensory output device comprises an image display. The feedback system is configured to modify the images received from the at least one video camera based on a known condition of the user. The feedback system can be configured to modify the images received from the at least one video camera by morphing, warping or replacing components of natural visual of the user that are damaged or otherwise reduced in effectiveness. The feedback system can be configured to transmit visual information as to shape, size, intensity, color, vertices and/or geometric calibration to a grid displayed on the image display. The at least one sensory output device can include a viewing screen with retinal tracking. The at least one sensory output device comprises a display screen and a pulse attachment. The pulse attachment can include a vibratory device coupled to the wearable device. The at least one sensory output device can output a live image stream displayed in a partial, inset and/or translucent overlay to aid the brain and central nervous system in constructing and understanding a coherent visual image of the information captured by the at least one imaging device.

In another embodiment a method of enhancing sensory information regarding the environment around a user is provided. The method includes positioning a wearable device on the head of a user; capturing image information from at least one imaging device on the wearable device; processing the captured image information, via a processor, to obtain processed image information; and transmitting the processed image information to an output device coupled to the wearable device to convey to the user information about the environment around the user.

In some embodiments, live images are captured, processed and redisplayed in real time through a display screen on the wearable device. The processing of the captured image information can include morphing, warping or replacing components of the captured image information to compensate for a particular condition of the user that renders the user's vision limited in capacity or otherwise reduced in effectiveness. The processed image information can be adjusted as to one or more of shape, size, intensity, color, vertices and/or geometric calibration to a grid, to improve or compensate for individual visual impairments. The processing of the captured image information can include processing the image information using at least one of 2D image mapping, 3D image warping, realtime texture mapping, channel manipulation, filters, edge enhancement, motion detection, and pattern matching. The method can include monitoring subsequent changes in configurations and adjustments of the processing of the captured images by the user to track progressive changes over time in the system. The wearable device can include an inward pointed optical sensor to track eyeball positioning information. The processing of the captured image information can include generating a partial inset and/or translucent overlay for display on the display screen of the device to aid the brain and central nervous system in constructing and understanding a coherent mental visual image. The device can include more than one display screens for viewing information transmitted to the output device. The at least one imaging device can include Wi-Fi-enabled video cameras.

In other embodiments systems and methods are provided for using hardware and software to acquire live images and sensory information, which is then streamed, processed and redisplayed in real time through goggles (or other wearable devices) or other prosthetic devices (to include vibrational and tonal devices), implanted imaging devices, or to a screen for the purpose of vision enhancement, correction, or to refocus visual information for delivery to the eye or body so as to in any way augment, improve, adjust, adapt and/or correct the perceptions perceived by individuals with impairments in order to gain sensory enhancement.

In some systems and methods, one or more camera, sensors, live video stream can be used to acquire, filter, adapt or augment raw images and data which are enhanced, corrected, distorted or otherwise modified for the purpose of adapting, adjusting, correcting for compensating the image then redisplayed through an external device to the eyes, nerves, sensory receptors or through an implanted device connected directly or indirectly to the visual cortex or any other area of the body or brain for the purpose of supplementing or extending sensory capacity, mitigating the effects of impaired senses by compensating, adjusting, morphing, warping or replacing components of natural visual, or other sensory systems that have been damaged, are non-existent, or limited in capacity, impaired, distorted, degenerated or otherwise reduced in effectiveness. In some embodiments, the individual or a second party can adjust the delivered visual information as to shape, size, intensity, color, vertices and/or geometric calibration to a grid calibrate, tune, and/or record effective enhancement parameters and distortion parameters that improve or compensate for individual visual impairments and then apply them in real time to ambient visual information.

The methods and systems disclosed herein can process images using reference shapes, colors, objects, images, vertices and/or dynamic calibration grids to adjust, tune, fine tune, modify preset and record for future use image modification parameters, signal processing parameters and modifiable configurations for use in the system. The methods and systems can use 2D image mapping, 3d image warping, realtime texture mapping, channel manipulation, filters, edge enhancement, motion detection, pattern matching and/or any combination of streaming, signal processing, software and/or hardware accelerated image mapping, vertex or pixel adjustment to dynamically alter video or audio streams in real time for use within the system.

The system can include an embedded or externally connected computer or microprocessor that is configured to adjust, monitor, track, modify, store, retrieve, analyze, report and process images, settings, parameters, configurations, subsequent changes in configurations and adjustments, and any other progressive changes over time in the system. Practical, graphical, etched, optical, printed, translucent, virtual or digitally overlaid focus marks, points, targets or rings can be provided to assist the user in maintaining proper eye alignment, position, calibration and/or focus.

In some embodiments, inward pointed cameras, cameras or an array of optical, or other sensors can be provided to receive or collect eyeball tracking or positioning information, which can be used to dynamically translate, transform, adjust, warp, calibrate, respond or compensate to the user's physical eye placement and movements.

In some embodiments, a live image stream can be displayed in a partial, inset and/or translucent overlay is used, animated or tracked in a manner to aid the brain and central nervous system in constructing and understanding a coherent mental visual image, and/or provide a virtual visual look around, wherein persistence of vision and mental visual reconstruction techniques are aided in reassembling vision from areas that would otherwise be blocked, obstructed or substantially deformed. In other embodiments, a live audio stream can be displayed in a partial, inset and/or translucent overlay is used, animated or tracked in a manner to aid the brain and central nervous system in constructing and understanding a coherent mental audio or visual concept, and/or provide a virtual experience, wherein persistence of sound and persistent audio reconstruction techniques are aided in reassembling sound from areas that would otherwise be blocked, obstructed or substantially deformed.

In some embodiments, a live image stream can be displayed in a partial, inset and/or translucent overlay is used, animated or tracked in a manner to aid the brain, body, and central nervous system in constructing and understanding a coherent mental and sensory experience, and/or provide a virtual memory experience, wherein persistence of vision, sound, memory and mental visual reconstruction techniques are aided in reassembling senses and memory from areas that would otherwise be blocked, obstructed or substantially deformed.

In some embodiments, a system in which an embedded or externally connected computer, attachment, or microprocessor is employed to adjust, monitor, track, modify, store, retrieve, analyze, report and process information, settings, parameters, configurations, subsequent changes in configurations and adjustments, and any other progressive changes over time in an environment, a person, or system.

### BRIEF DESCRIPTION OF THE DRAWINGS

FIGS. 1A and 1B illustrates an exemplary host unit headset with view screen, audio earplugs, CPU, and headset with cameras.

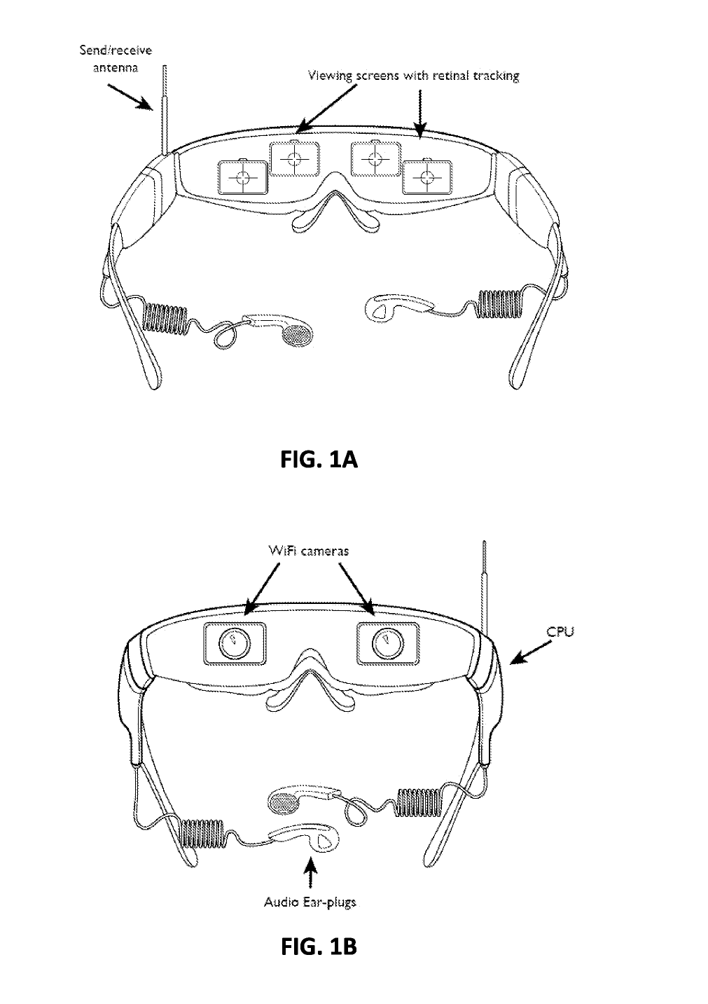

FIG. 2 illustrates an exemplary sensory device attachment.

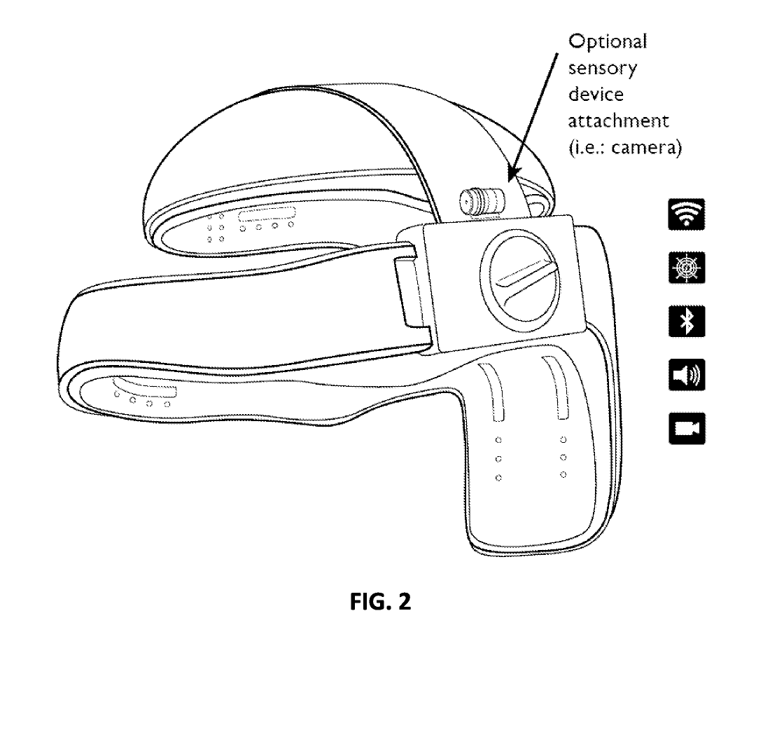

FIG. 3 illustrates a sensory device system for identifying objections around a user.

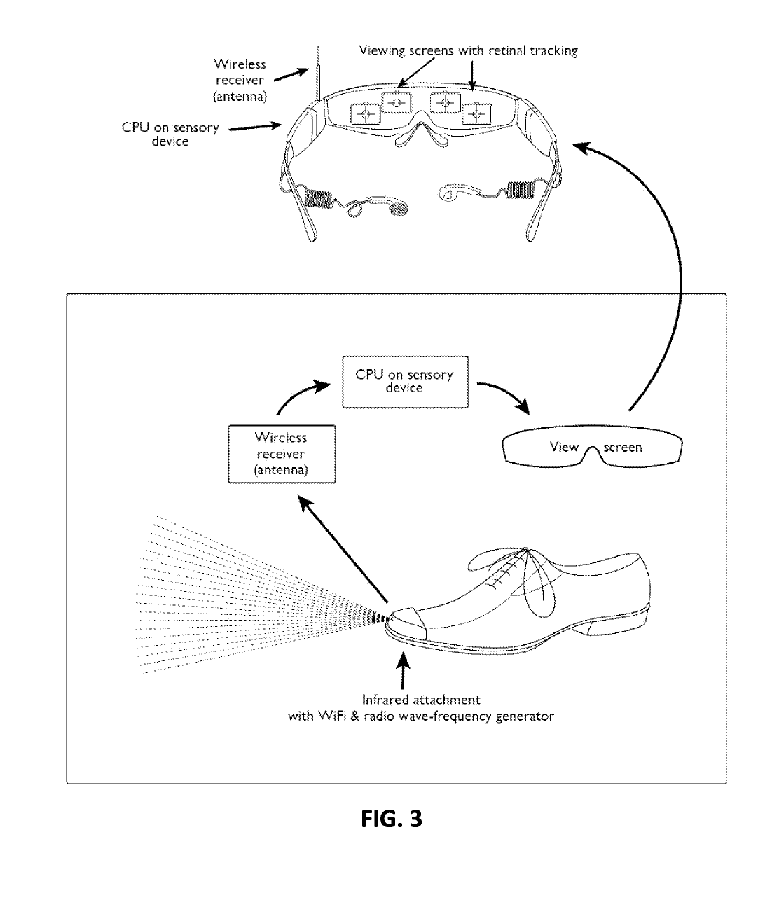

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

### Definitions

As used herein, the term “sensory” means awareness of and/or relating to sensation, to the perception of a stimulus, to the voyage made by incoming nerve impulses from the sense organs to the nerve centers or to the senses themselves.

As used herein, the term “perceptions” mean any one of dozens of ways of sensing or apprehending things in the environment by means of senses or of the mind. For example, sight, sound, smell, temperature are all methods of gaining data to perceive something.

As used herein, the term “CPU” or “Processors” means a central processing unit that engages a series of actions to produce a given result.

As used herein, the term “raw data image” means unprocessed data information, without change or alteration.

As used herein, the term “reprocessed image” means data filtered through a given series of steps to a specified result.

As used herein, the term “grid” means a series of graph based lines which represent X and Y values.

As used herein, the term “database” means an organized classification and storage of groups of identified information.

As used herein, the term “pre-mapped assessment” means a grid of X and Y values assessed in advance with the specific intent of use as a base formula.

As used herein, the term “processing algorithm” means a mathematical formula created to interpret and counter create an existing Grid X and Y aberrations, and convert them into a 0.

As used herein, the term “attachment” means a module which attaches to a processing unit to provide supplementary and addition types of perceptual or sensory information.

As used herein, the term “sensory device” means any device which can provide a form of perceived perceptual information, including any device that can provide visual, auditory, tactile (e.g., touch, pressure), olfactory (e.g., smell), balance, or any combination of these other perceptual information.

The invention is composed of a host unit, a computer processor, data base, reception devices, capture devices, transmission devices, and delivery modules. Though not limited to eyesight problems, the example above will serve to summarize how the inventions works. The person wearing the host unit, in this case an eyeglass style embodiment, cannot see well; the unit uses 2 or 3 cameras to capture (data perceptors) what the user is looking at, the information is processed through a computer chip and identified, then compared to a pre-mapped version of the users' visual disability. The raw data containing the absent/missing sight perception is then converted to an adjusted image which will compensate for the missing vision perception and presented to the user in a meaningful manner through any number of modalities which can give the user an understanding, or sufficient perception to produce the same result in the user. Where the vision is skewed, the processor re-skews it to create an image which will be meaningful to the user and cause the user to interpret the new image as normal rather than skewed. The processed image is transmitted to the viewing screen in the user's headset, and the user will perceive an actual representation of what they are looking at in their mind instead of a skewed image. In this case, the user was looking at a face which appeared distorted to her, which the invention made normal for her by reprocessing the image. Additionally, it could present information to the user by other sense's, by any number of add-on attachments, plug-ins or applications, not limited to pulse signal, vibration, auditory, alarms, light, etc. i.e., the image could have been projected by other means to the brain by 3D, or an implanted device, or a unique projection style which made the image, or via hologram projection. If the user were near blind, another sensory device could deliver the information to the user in an alternative manner such as a tone, or a pulse or another representative sense or symbol, whichever may appear visible or meaningful to the brain.

### Exemplary Embodiment

The following is an exemplary embodiment; however there are other embodiments that can be executed in separate parts and in different circumstances and applications and can be performed by various combinations of machine, computer, and/or human act.

Set-Up:

A perception device is provided to gather data. Such a device can be used to obtain any relevant data about the environment. For example, cameras can provide image information, microphones can provide sound information, radar can provide object detection information, etc.

An algorithm is created to identify and classify the data gathered and to help determine the next step in processing that information. For example, if the camera data identified the face of a person by comparing it to an existing data base for known faces, it can then identify the person to the user verbally through headphones or other means. In addition, or alternatively, the image can be processed in any manner to render it to appear normal to the user.

An algorithm can also be created to transform the data and send to a delivery module. The delivery module can include programming the device based on specific needs of the user, or by a Professional Specialist. For example, an eye doctor could perform an eye exam and make a digital map of the user's optical problems. This map would be used to create a custom algorithm to create a compensating image, or other meaningful output, for that person's eyesight perception problems. This database and conversion template of the user's malady program can be loaded into the device computer and control operation of the device.

In another example a user may use a Geiger counter attachment as a radiation perception device (perception data gathering). That is, the information is sent to the computer for identification and the computer has a primary function in this case, which is to inform the user by whichever modality was opted to deliver this information. For example, a special sound sent to the users cell phone, a headset, a video screen graphic image identifying the direction of the radiation and type of radiation and digital signal of its intensity with other warnings.

### Set up By User:

The user may attempt to set the defaults on this device with set-up software via his own computer, on-line and through set-up support, or use a trained specialist. In a simple case, the user can set defaults manually. For example, low-light vision impairment can be improved by allowing a user to manually adjust the brightness level and the system can maintain that level of light penetration and delivery.

In another example, a person who has some occasional problem with momentary forgetfulness, as in pre-Alzheimers, could benefit from the systems and methods disclosed herein by using a GPS adaptor (or other location sensing system). The unit can gather data by a number of sensors, physical, mental, directional and be programmed to repetitively remind the person who they are and how to get where they are going. It can also alert someone in a remote location as to the person's location and possible trouble.

### Exemplary Enhancement Devices

This device can be worn, like glasses, but through its sensory receptors and processor, it produces virtual enhanced vision for the user. The camera captures raw images which retinal scanners tell the cameras what the user is looking at. The camera (raw data perception sensor, in this case) send the data to the CPU which then runs the data through a series of filters to identify the data and to determine what to do with it. Depending on the programming, the CPU does what it has been instructed to do with the data, whether skewing to reshape an image so the user can see it, or issuing a warning that an object is very close, or a room exit is in a certain direction, after processing, these results are displayed on the device screens or communicated via the preferred means to the user.

Attachments and add-ons of other devices can be made to attach to the base unit. These include, but are not limited to sensing devices, and hybrid devices, using radar, sonar, echo technology, gamma, neutron, ultra-sonic, ultra-sound, Infra-red, frequency use, modulation, reflective technology, texture/light feedback, density, heat, signature and/or composition identification, magnetics, air quality, radioactivity and any other means of sensory assistive information.

For example: an IR sensor could be attached to the headset or shoes, and gather information on the presence/distance of objects in the room. This information would be processed by the chip and translated into a feedback which can be meaningful to the user through the methods listed above.

Information gathered from the above devices can be transformed into a mapping template which accomplishes at least a useful form of information which can be delivered to the user in raw format or in a template which has been pre-determined to relay information in defined patterns, i.e., a means to identify, but not limited to, objects in a room, exits, live objects, etc.

Another example: an IR, or other sensing device is place on the user's shoes. The information transferred to the chip is used to alert the user of upcoming objects, rises in the pavement, cracks/potholes, etc., thus increasing safety through information, reducing user stress and allowing the user increased efficiency in independent living and mobility. The transformation of this information is done through a chip/processor.

The information is delivered to the user in any number of formats. Such as, but not limited to, pulse device, sound variation device, light variation device, pressure reactive device, image creation-internal and/or external, any audio-visual device, vocal command/warning, color, frequency, modulation, or other means of sensory communication including headsets, sensory gloves or other sensory wearables.

For example: a strap on pressure pad device could be used around one's head. Processed information is transferred from the processor to the pressure pad device in a recognized pattern of varying pressure points in the device. This could indicate to the user the presence and distance of room objects, or other things, and alert the user to them.

### Learning Language

The information gathered from these sensors can be translated into any number of feedback devices listed above in a standard format through many means; one may prefer sound, another light adjustment, color warnings, pressure adjustments, alarms or signals of any sensation. There are numerous languages for various disabilities; Blind use “Braille”, deaf use

“Signing”. These can be programmed into the CPU, or a custom language can be adapted by the user as his/her own modality of the device use.

Artificial intelligence

The device can identify objects from a preloaded database. It can learn objects and people through software and add them to the existing data base. It can identify, predict, and suggest reactions. It can give vocal instructions available in the data base. It can remember room maps, GPS, streets, accesses, store lay-outs, people names, face recognition, history, account info, voices. It can accept verbal commands, and contact others via the web, telephone connection, or other device. These are all to assist the user in location orientation and the handling of everyday living.

The database is designed to accept additional information on the users' physical condition and the feedback system can be used to alert the user to information provided by other add-ons; i.e., stress level has risen, heart beat is way above normal. The invention can tell the user “Rest!” Or, “get assistance.” If the person is injured, it can be used to provide contact assistance to remote assistance who can then advise on the treatment and I.D. of the user.

The invention can attach to a vibrational or other sensory means of identification of objects/people performed by various combinations of machine, computer, and/or human interface.

By use of a frequency modulator and tone variations this device can be used for trance or semi-trance induction to assist in healing, medical procedure, or learning and memory state adjustment.

By use of attached laser device the unit is capable of being a mobile area mapping device.

By use of attachment of a portable ground radar scanner the unit is capable of being a location radar device to identify objects and structures underground, inside walls, hidden, camouflaged from a mobile or stationary point.

Any section of this invention could be used as a separate entity or with other business models to observe, modify and/or enhancement of sensory perception, interpretation, and reaction.

### Disability & Elderly

The systems and methods disclosed herein can be used to treat or improve eye-sight related visual impairment disorders, including, but not limited to those from Refractive Errors, Macular Degeneration, Cataract, Diabetic Retinopathy, Glaucoma, Amblyopia, and Strabismus.

Using the systems and methods outlined in the description above, for example, a captured image can be processed and filtered, using a custom pre-programmed algorithms designed to re-interpret visual perception for that user the invention, to aid the user in converting distorted or weakened vision into corrected meaningful perception and images. It can receive raw data, reprocess it and transmit it to the eyes for reinterpretation and create a meaningful image in the brain. Where implanted devices are developed it can transmit data to such a device, or where other forms of corrective image projection or injection occur to nervous system or brain, this invention can be used to gather raw data, reprocess it if necessary, and transmit it to a secondary device.

The systems and systems and methods disclosed herein can be used to provide text or visual enhancement. For example, using the systems and methods outlined herein, a captured image can be processed and filtered, using a custom pre-programmed algorithms designed to re-interpret visual perception for that user. The invention can make a skewed text image appear normal to the user. This includes skewing, warping, lighten, darken, enlarge, shrink, create a 2D image, 3D image, text to voice or braille, or manipulate in any other way to project or deliver information in a format which will transmit data to cause an image or familiar term or meaningful symbol to the user's brain to effect recognizable communication by the user.

Directional help can be provided by the systems and methods disclosed herein. For example, a map or use database of known locations (GPS maps, or similar maps with pre scanned disability code and information) can be created. Using the methods and systems described herein, system can create a layout of the present location, compare the information to known locations, draw a match from the database or add the new map as a new location. The location may have preloaded maps available by any means of transmission to a recognized device (e.g., in a manner similar to Bluetooth and cellular recognition) for instant sharing pre-loaded maps via Wi-Fi or any similar device. The unit can issue directional commands based on the map data. It can also be used to direct a disoriented user to a specific location (e.g., home, exit, restroom, etc.).

Hearing Impairment can also be treated by the systems and methods disclosed herein. Based on the capture/reprocess description above, the invention can re-shape sound so that the user can hear in a normal manner, despite hearing impairment distortion of normal sound. The input sound is compared to the users hearing chart information and reprocessed in a manner can cause the reshaped sound to custom sound like normal to the user through any number of process filters like EQ adjustments, and Artificial intelligence and algorithms to produce sound which make imperceptible sounds appear normal to the user. The systems and methods can also use electronic signing (sign language) through a different perceptible delivery mode (not limited to digital display, pressure point, vibrational) closed captioning, closed captioning translation to another form of delivery, or finger pads or foot pad.

Military and Other Security Applications

Using the process description above the invention can collect data and identify chemical, toxins, explosives, forensic interpretation of body-language/physiological patterns and voice patterns, facial recognition, GPS location, reception of satellite recon, give directions, identify people, signal, and object location and movement, auto issue alarms/warnings/and advisories based on local and remote information. Self-charging solar cell. Can transmit Frequency change, frequency masking, frequency block-out, create mental preparation through NLP/frequency/and sound for Hypo-metabolic stasis sleep, use sonar, radar, ultra-sound, gamma sensor, neutron sensor, motions sensor, heat signature with life form and object identification for user or remotely. This unit can be left somewhere, stay charged by sunlight, activate with motion presence, and scan the environment for people things, chemicals and report raw data via any attached communication device frequency.

### Police

As above with emphasis on forensic assessment of physiological manifestations indicating truth, lying, or danger. Police can use to de-stress themselves or monitor their own physiology before, during or after situational encounters. Facial recognition and license plate/registration information could be particularly useful in identification of un-associated incidental encounters with known criminals at large.

### Medical and Health Applications

In conjunction with data providing attachments and using the process described above the invention can provide the practitioner with a multiple array medical condition analysis probabilities based on prevalent indicators provided by tests, bodily functions and illness manifestations. An artificial intelligence agent can list likely assessment, request additional input, and give recommended procedures and cautions. The invention can also assist in user temperament adjustment by emanating preset sound, frequencies and/or vibrations and tones to induce different states of consciousness, including, but not limited to cerebral metabolic rate variance and monitoring, euthermic measurement and correction, sleep induction, rhythmical muscle stimulation, physiological monitoring with auto-correction and remote reporting and handling these can include alerts/advisories and remote help/contact, and produce frequencies which may aid in healing or neutralizing certain maladies. The unit can store complete medical records in raw or encrypted format or can make them immediately available from a cloud based resource to qualified registered personal with a password.

The interpretation of a user's personal assessment of physiological condition for exercise, weight loss, conditioning, caloric use and intake, and recommendations can be added. In addition, the system can provide relaxation and other mental state changing/producing tones, music, Neural Linguistic Programming and stress alarms and advisories. Can provide direct medical support when connected online or via another communication device. GPS can provide emergency location assistance. The system can also provide environmental conditions and life form identification. For example, based on having the correct attachment and using the processing techniques as described above the environment can be monitored for any number of toxins, air quality, chemicals, magnetic resonance, wavelengths, various frequencies, forms of radiation, heat, life form and inert signatures. Where complex data may need to be uploaded to another location for complete lab analysis, the GPS location I.D. and probability reports can be drawn from a comparative database immediately.

Psychological and Mental conditioning

The unit can additionally produce and deliver trance, hypnotic, and neural linguistic programming, magnetic pulses and other modalities to produce a variety of induced mental states.

### Educational

The invention can be used for a learning aid based on having an attachment sensor and using the processing as described above to deliver study materials in the form of text, video, audio. It can monitor the user's mental patterns while studying and note areas of difficulty. It can use Neural Linguistic programming and mental state induction sounds, tones, suggestions and frequencies to prepare one for study, or to keep a student studying. The unit can be used to access study materials and remote online assistance if Wi-Fi active or connected to a communication device.

### Social and Business

The invention can be used to increase social interaction and business efficiency when having an attachment sensor and using the processing as described above by monitoring stress levels in the user's own voice and others. By monitoring physiological changes in self and others, as well as body language, and emotional reaction the user can gauge the type of conversation to engage in, or discontinue. The unit can make stress warnings and give recommendations to the user based on his/her known personality traits and stresses formulation.

The invention can save the name-forgetting user stress and help the memory-challenged users with its personal Memory bank, an attachment which stores facial images and known information on the person (birthdates, spouse/kids/pet names and other related information). As soon as the retinal tracker spots the individual(s) the data base places a name of the person on the screen, and optionally, a vocal notice with the other familiar information). The user is then able to engage social contact without embarrassment or personal remorse.

### Various Advantages

Prior inventions are limited in use in several ways. They are focused on one disability or loss of perception, or perception enhancement, and are not easily adapted to a different use, different input, nor different output. The invention is easily adaptable by attaching a different sensing device to gather specific data, update the data base and processors with an application directed at that specific use, and attach it to a perception delivery device such as LED screen, earphone, pressure device, etc. Prior inventions do not have newer and faster processors which give access to increased function and utility for the user. This invention has the advantage of being multi-purpose by use of increased processor and advanced computer electronics power allowing for the adaption of new and novel uses unavailable before.

Conventional systems are also bigger, heavier, slower, limited in scope, and much less able to be mobile. The invention is designed to be mobile and can be attached to a cell phone, an iPad type device, laptop, etc. if desired. In addition, the systems and methods disclosed herein can include access to the internet, remote access and support, nor Wi-Fi and blue-tooth type services, providing significant improvements over conventional systems without such access. These or similar functions can be used in the disclosed systems. The system and methods disclosed herein can also provide access to software or hardware that can assist in separate, and the combined use of calculations, distance, object interpretation, facial recognition, retinal tracking, artificial intelligence, or other software which greatly improve the scope, use and efficiency of the disclosed systems.

Conventional systems also lack the functionality of a personal perception grid used in the calculation of producing a personalized hybrid perception as disclosed herein. This unique concept, combined with instant raw data, instant processing to identify, filter, and restructuring the information into a pre-programmed filter produces meaningful personal results, which are customized to the user, and is completely unique and unlike any other existing device.

### Additional Embodiments

As discussed above, various sensory information can be obtained (e.g., sound, light/vision, chemical frequency and wave-length, shape/form/objects, heat) and processed. For example, the system can captures images, wavelength, and/or frequency, and use that information to identify and relate information to a user. The relation of information can comprise sending an audio transmission, send it in/out via the web, FM, or visual/auditory signals. The device can update earlier room maps, objects, people, and elements. In addition, the device can reprocess data to compare a recognizable form (e.g., by processing a captured verbal statement, which may be too fast, too high, etc., the device can process it and slow it down and makes it discernable for a user with auditory difficulties or limitations. The device can also be programmed to compute distortion/anomalies/data from all sectors and view an entire field.

The device can be configured to project data/images to one or more screens (e.g., LCD screens) in glasses to compute and convert information to user into a meaningful form, whether auditory, visual (assist vision impaired users), provide chemical, elemental, gas, genetic and heat sensor data analysis and conversion information to the user. In addition, the system can adjust sound as necessary, interface video stream from separate cameras, follow eye movement, and/or focus on a particular object by zooming in on an area of focus target reset to normal screen. Other image modifications can include zoom out, brighten zoom area, darken zoom area, sharpen zoom area, skew left/right area, brighten default area, darken default area, sharpen default area, and skew default area.

The image can be processed to project to screen in various manners. For example, the image can be cascade image like waterfall, starburst image (multiple break-outs of same image), Christmas tree ornament image x12 bulbs float across screen, isolate and outline image. (darken background, or brighten foreground, reversible), IR image, Strobe image, strobe image at multispeeds, flash image left to right, flash image background, shade image, change image speed, move image around screen and stop, freeze, start, enlarge or skew image

In another embodiment, the system can accept a default corneal map image, create an algorithm based on that image, create a test platen, create an auto calibrate for test platen, create a manual tweak for test platen, create a 3d image, reskew a skewed image based on digital map above, text to voice viewed text with on-off, interface with facial recognition program data to voice from image data base, audio to data voice commands, scan and map room objects and store location and gps data.

In some embodiments, full field study (matrix)-takes the full field of observed objects into consideration to compute a normal view. Using Artificial Intelligence of known data, device will assess existing view, estimate known and unknown anomalies. Use an algorithm to recomputed view into a meaningful presentation for the viewer by identifying all different fields presentation, estimating the impact of each field individually, estimating the cross impact of each field upon other field, estimating the combined impact of all fields upon the full field, evaluating comparative field disruption by individual anomalies, evaluating comparative field disruption by multiple anomalies, recommending “best” corrective displays created in order of set defaults or preference for singular area of field or whole field allows manual correction by area of whole field or part of field using intuitive presets. In some embodiments, conductive sound can be conveyed through frame.

### Summary

Various wearable devices that can detect objects and elements are provided. As discussed above, in some embodiments these devices can map multiple elements in the environmental that can convert analog and digital information into multiple formats. Device can be programmed to convert data into other meaningful formats. For example, the devices can sense and identify chemical compounds, or capture multiple light patterns/images in a defined field and convert light patterns to be viewed through multiple filter (infra-red, sound frequencies, gamma, etc.).

Such devices can also (or alternatively) sense and identify life forms, transmit location, and communicate what it has identified in multiple forms (speech, pulse, light, image projection, and other means). They can scan a location to identify objects, map objects, record objects, and update object locations.

Various embodiments of the invention include a goggles-style headset with various sense receptors for aiding the user in capturing raw information, processing that information to analyze and identify data and inadequate perceptions, and change the data by means of a CPU into sensory information which will provide meaningful and comprehensive information to the user through the device and its attachments.

One embodiment of the invention is used as a sight enhancement device which is used to aid sight deficient individuals by creating images specially processed to accommodate their own visual deficiency so that their eyes can interpret the processed image as the original items which they're looking at. It has two cameras built into it, with a third camera for 3D imaging. The cameras capture raw data from wherever the user looks. The data captured is exacted by the use of a built in retina tracking device which aims the cameras wherever the user's eyes are directed. For many sensory enhancement attachments a customized Grid Map of the users' deficiency is assessed. That information is used to create algorithms which will counter and balance the users' deficiency within the processing mode.

The CPU in this example has already been programmed to minor the users eye problem and is instructed to create a processed images to compensate and correct them in such a way that the output is perfectly matched, re-arranged so that the reshaped images appear on the user's screen and what they then see in their brain is how a normal image would to a non-impaired user.

The raw info goes from the lens to the CPU where it is filtered for identity analysis, reshaping, and is then sent to the viewing screen for view by the user. When the user looks at the irregular image it appears normal in his brain because the image has been rearranged through intensive processing in order to tweak the users brain into seeing the real image. The unit has ports for add-ons that can support a variety of object identity and location devices as well as personal perception enhancement devices. One, an Infra-red attachment, sends back information on floor irregularities and other object locations. When the CPU finishes processing that information, it sends to the user a bright red dot on his screen. It's a warning signal for him that there's a bump, crack or hole very nearby. The database on the unit has a location map of things in this room from previous visits, or creates a new one by scan and advises him verbally, by other sense perception, by dots, & shadows, on the screen, or other means, where the objects are. Another sensor monitors stress increase information and alerts the user by a selected tone or flashing light. It can provide music, tones or other methods of calming the user down and reducing his/her stress level.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A sensory enhancement system comprising:
a head mounted, wearable device with at least one sensory output device for conveying information about the surrounding environment to a user;
at least one enhancement device coupled to the wearable device, the enhancement device including:
at least one imaging device configured to receive real-time images, and
a feedback system configured to process the real-time images to obtain the information about the surrounding environment and to transmit the information to the sensory output device.

2. The system of claim 1, wherein the imaging device comprises at least one video camera and the at least one sensory output device comprises an image display,
the feedback system being configured to modify the images received from the at least one video camera based on a known condition of the user.

3. The system of claim 2, wherein the feedback system is configured to modify the images received from the at least one video camera by morphing, warping or replacing components of natural visual of the user that are damaged or otherwise reduced in effectiveness.

4. The system of claim 2, wherein the feedback system is configured to transmit visual information as to shape, size, intensity, color, vertices and/or geometric calibration to a grid displayed on the image display.

5. The system of claim 1, wherein the at least one sensory output device comprises a viewing screen with retinal tracking.

6. The system of claim 1, wherein the at least one sensory output device comprises a display screen and a pulse attachment.

7. The system of claim 6, wherein the pulse attachment comprises a vibratory device coupled to the wearable device.

8. The system of claim 1, wherein the at least one sensory output device outputs a live image stream displayed in a partial, inset and/or translucent overlay to aid the brain and central nervous system in constructing and understanding a coherent visual image of the information captured by the at least one imaging device.

9. A method of enhancing sensory information regarding the environment around a user, the method comprising:
positioning a wearable device on the head of a user;
capturing image information from at least one imaging device on the wearable device;
processing the captured image information, via a processor, to obtain processed image information;
transmitting the processed image information to an output device coupled to the wearable device to convey to the user information about the environment around the user.

10. The method of claim 1, wherein live images are captured, processed and redisplayed in real time through a display screen on the wearable device.

11. The method of claim 10, wherein the processing of the captured image information comprises morphing, warping or replacing components of the captured image information to compensate for a particular condition of the user that renders the user's vision limited in capacity or otherwise reduced in effectiveness.

12. The method of claim 10, wherein the processed image information is adjusted as to one or more of shape, size, intensity, color, vertices and/or geometric calibration to a grid, to improve or compensate for individual visual impairments.

13. The method of claim 10, wherein the processing of the captured image information comprises processing the image information using at least one of 2D image mapping, 3D image warping, realtime texture mapping, channel manipulation, filters, edge enhancement, motion detection, and pattern matching.

14. The method of claim 10, further comprising monitoring subsequent changes in configurations and adjustments of the processing of the captured images by the user to track progressive changes over time in the system.

15. The method of claim 10, wherein the wearable device comprises an inward pointed optical sensor to track eyeball positioning information.

16. The method of claim 10, wherein the processing of the captured image information comprises generating a partial inset and/or translucent overlay for display on the display screen of the device to aid the brain and central nervous system in constructing and understanding a coherent mental visual image.

17. The method of claim 10, wherein the device comprises more than one display screens for viewing information transmitted to the output device.

18. The method of claim 9, wherein the at least one imaging device comprises wi-fi-enabled video cameras.
